(19) United States
(12) Patent Application Publication
(10) Pub. No.: US 2012/0285939 A1
(43) Pub. Date: Nov. 15, 2012

(54) METHOD FOR CONTROLLING THE ADVANCEMENT OF THE WEAR-AWAY WIRE ELECTRODE OF WELDING AND/OR SOLDERING SYSTEMS AND SUCH A WELDING AND/OR SOLDERING SYSTEM

(75) Inventors: Udo-Ralf Kessler, Fernwald (DE); Ralf Hellmig, Solms (DE); Siegfried Raddatz, Wettenberg (DE)

(73) Assignee: ALEXANDER BINZEL SCHWEISSTECHNIK GMBH & CO. KG, Buseck (DE)

(21) Appl. No.: 13/512,067

(22) PCT Filed: Dec. 16, 2010
(86) PCT No.: PCT/EP2010/069953

§ 371 Date: May 25, 2012

(30) Foreign Application Priority Data
Dec. 18, 2009 (DE) 10 2009 058 869.8

(51) Int. Cl. B23K 9/10

(52) U.S. Cl. 219/137.71

(57) ABSTRACT

The present invention relates to a method for universally controlling the advancement of the wear-away wire electrode (3) of welding and/or soldering systems, wherein the wire electrode (3) is taken from a wire supply (2) and fed to a welding head (8) from the wire supply (2) through a protective tube (1), wherein the wire electrode (3) is both advanced by means of a push drive (4) and pulled by means of a pull drive (5), which are preferably arranged in the region of the respective ends of the protective tube (1) that are actuated in keeping with a required advancement speed of the wire electrode (3). The pull drive is controlled in accordance with the actuating signals for the push drive.

The present invention relates to an electronic circuit for connecting a pull drive, which is designed and intended to pull a wire electrode through a protective tube, to a welding and/or soldering system which comprises a push drive for advancing a wire electrode.

The present invention also relates to a method for universally controlling the advancement of the wear-away wire electrode of welding and/or soldering systems, wherein the wire electrode is taken from a wire supply and fed to a welding head from the wire supply through a protective tube, wherein the wire electrode is both advanced by means of a push drive and pulled by means of a pull drive, which are preferably arranged in the region of the respective ends of the protective tube that are actuated in keeping with a required advancement speed of the wire electrode.

Welding and soldering devices with wear-away wire electrodes are usually available with tube packets in standard lengths of up to approximately 8 m. These tube packets are used to ensure the feeding of wire, current and protective gas, and optionally a fluid, to the process.

Since in longer designs of tube packets, the friction between the wire electrode and tube jacket becomes increasingly greater, the rear so-called push drive in the welding current source or in a wire advancement device is no longer able to provide sufficient force to feed the wire to the welding head. The consequence is that the wire transport starts to stall and may even come to a stand still. As a result, a high quality welding process is not ensured. In order to produce longer tube packets nonetheless, an additional pull drive is generally used in the vicinity of the wire discharge in the blowpipe, which applies traction to the wire.

Several possibilities exist to implement and actuate said front pull drive. One possibility of actuation is to carry out the control from the current source. For this purpose, the current source control must be designed appropriately. However, given that there is a plurality of motors for pull drives, and there are several manufacturers for various pull welding drives, the manufacturers of current sources offer a current source control only to a limited extent, usually only for their own pull drives.

Several additional adaptation solutions also exist, which in part work passively via a kind of self adjustment, or they are implemented, on the other hand, via active amplifier circuits. However, the latter are also designed more or less only for one blowpipe type.

Thus, during the actuation of the push motor using a rotary pulse generator or tachogenerator, the motor is usually adjusted via a control which is associated with the current source. In this adjustment, the current speed is determined via a rotary pulse generator or tachogenerator and transmitted via pulses or voltage values to the control. This is an active adjustment which is very precise. However, it requires a processing unit in the current source as well as a rotary pulse generator or tachogenerator at the pull motor, which results in high costs.

The actuation of the push motor can also take place via a constant moment. Assuming that the motor current is proportional to the torsional moment, a constant moment control can occur by means of a constantly impressed motor current. However, this active adjustment is fluctuating and in principle similar to the actuation via a resistance board.

The aim of the present invention is to provide the possibility of universally using pull drives having different welding current generators provided with a push drive.

The aim is achieved by an electronic circuit, which is characterized in that the electronic circuit is designed to receive—particularly parasitically tapped—actuation signals for the push drive, and to control and/or adjust the pull drive using the current actuation signals for the respective push drive, synchronously with the push drive and at the same drive speed.

In terms of the process, the aim is achieved by a method which is characterized in that the pull drive is controlled and/or adjusted by using and/or processing actuation signals for the push drive.

The invention is based on the considerations that, when actuating the push motor via a resistance board, the motor is series connected via a resistor. When the motor draws more current during its operation, the voltage decreases correspondingly more strongly at the resistor, and the motor thus decelerates. When the motor draws less current, the voltage accordingly decreases less, and the motor consequently accelerates again. However, this passive adjustment is fluctuating.

The method according to the invention and the welding and/or soldering system according to the invention having a wear-away electrode are characterized by the following advantages.

In an advantageous embodiment, a reservoir is provided, in which characteristic curves, particularly voltage-rpm characteristic curves for different pull drives are stored and/or in that a reservoir is provided in which characteristic curves, particularly voltage-rpm characteristic curves for different pull drives are stored, wherein a fitting characteristic curve is selectable and/or adjustable by means of a DIP switch and/or by software.

In particular, it can be provided according to the invention that the electronic circuit takes into account a selected characteristic curve in the determination of the compensation parameters and/or in the generation of actuation signals for the pull drive, and/or that a selected characteristic curve is taken into account in the determination of the compensation parameters and/or in the generation of actuation signals for the pull drive.

In a special embodiment, the electronic circuit is designed to receive and process a pulse width modulated actuation signal for the push drive. Alternatively or additionally, it can also be provided that the electronic circuit determines and processes, for the determination of the compensation parameters, the time integral over the voltage or the current strength of the actuation signal for the push drive.

In a particularly advantageous embodiment, the pull drive is controlled via a pulse width modulation (PWM). However, it is also possible to control the pull drive by other control means, such as, for example, by voltage modulation or by current modulation.

In an advantageous embodiment of the invention, in a working mode, the drive speed of the pull drive and/or the equality of the drive speeds of the push drive and the pull drive are monitored, continuously, or at predetermined or predeterminable time intervals.

A particularly advantageous welding and/or soldering system, or tube packet for a welding and/or soldering system, or pull drive is one that is provided with an electronic circuit according to the invention.

The electronic circuit is universally usable for different welding and/or soldering systems with wear-away wire electrode, which already comprise a push drive, for the connection of an additional pull drive.

On the basis of a signal sampling on the wire advancement device (push drive), the slightest changes in speed, which may occur, for example, due to a bend in the tube packet, can be detected immediately. As a result, the equipment is largely independent of the signal shape.

Since, according to the invention, a detection and conversion and/or compensation by calculation of the actuation signals by the push motor occurs, no special configuration needs to be considered by the user at the time of a new installation, and consequently the installation is as rapid as possible for the user.

Since the speed values for the pull motor are calculated independently, no sensor system is needed for the speed adaptation.

Moreover, due to the determination of the electromotive force (EMF) of the pull motor, no sensor system is needed for receiving the actual drive speed.

Since a readjustment of the actuating variable (target value) occurs on the basis of the signal derived from the electromotive force, which signal represents the actual speed of the pull motor, a signal processing is coupled directly with the motor. As a result, there are no physical effects caused by a sensor system, such as, for example, a rotary pulse generator, or other similar components. In this way, there are no interposed interfering parameters.

Finally, the calculated actuating variables are preferably used directly on the pull motor.

Preferred embodiments of the method according to the invention are indicated in the dependent claims.

The current drive speed of the pull motor can be measured advantageously via the electromotive force. Said electromotive force represents, in the sampling gap, when no current is applied to the pull motor, the drive speed thereof, and it can be used advantageously for the adjustment of the pull motor.

The fitting characteristic curve for the pull motor used is adjusted advantageously via a DIP (Dual In line Package) switch and/or software.

In an advantageous embodiment of the method according to the invention, it is provided that, from actuation signals for the push drive, compensation parameters are determined, and that, in a working mode, the pull drive is controlled and/or adjusted using the respective current actuation signals for the push drive, and using the determined compensation parameters, synchronously with the push drive and at the same drive speed. The actuation signals for the push drive can advantageously be tapped parasitically.

The tapping of the actuation signals and/or the determination of the actuation signals can occur advantageously in a learning mode of the electronic circuit. After completing a learning routine in which the required compensation parameters are determined, the electronic circuit can then be switched to a working mode, in which the pull drive is controlled and/or adjusted using the compensation parameters and the actuation signals for the push drive.

In particular, it can be provided according to the invention that the current drive speed of the pull motor is measured via the electromotive force which, in the sampling gap, when no current is applied to the pull motor, represents the speed thereof, and is used for the control and/or adjustment of the pull motor.

In particular, it can also be provided according to the invention that a characteristic curve fitting the pull motor used is retrieved from a memory in which characteristic curves of different pull motors are stored, and that the fitting characteristic curve is definitively set as a fixed variable, or a characteristic curve fitting the pull motor used is retrieved from a memory in which characteristic curves of different pull motors are stored, and that said fitting characteristic curve is definitively retrieved and/or set, as a fixed variable, via a DIP switch and/or software.

In a particularly advantageous embodiment, for the determination of the compensation parameters, the wire speed is determined, and at the same time the associated actuation signals for the push motor are measured. It is also advantageous to provide that, for the determination of the compensation parameters for different wire speeds, the associated actuation signals for the push motor are measured and/or processed.

The pull motor is adjusted preferably using the compensation parameters in the working mode of the system to the same drive speed as the push motor.

It can be particularly advantageous to provide that the actuation signals of the push motor are determined via a galvanically separated input or via a sensor. According to the invention, it is also possible that the actuation signals of the push motor are determined via a galvanically separated input or via a sensor, and with the selected characteristic curve compensated by calculation and/or adapted, and a resulting new variable is used as target value for the adjustment of the pull motor in the operating state.

For example, the pull motor can be actuated via a pulse width modulation (PWM) or a voltage modulation or a current modulation.

As already mentioned, it can advantageously be provided that, in a working mode, the drive speed of the pull drive and/or the equality of the drive speeds of the push drive and the pull drive are monitored, continuously, or at predetermined or predeterminable time intervals.

As has also been mentioned already, it can advantageously be provided in particular that—for example, repeatedly at predetermined time intervals—the drive speed of the motor of the pull drive is determined via the electromotive force (EMF) which then represents, in the sampling gap, when no current is applied to the pull motor, the drive speed of the motor of the pull drive (back EMF). In addition, it can be provided that, from said drive speed and the required target speed for the actuation of the motor of the push drive, a duty factor of the pulse width modulation (PWM) for the pull drive is adjusted.

In particular, to verify the duty factor for the pull drive, and optionally correct it, the process of determining the duty factor should be repeated at predetermined time intervals. For the actuation of the pull motor, in an advantageous embodiment, the drive speed of the pull motor is determined at which a driving roller of the pull motor for the advancement of the wire electrode presents no slip on the wire electrode, and runs at a circumferential speed that corresponds exactly to the advancement speed of the wire electrode that is reached by the push motor. This point in time can be referred to as the transition from a “slipping through” to a “gripping” of the drive portion of the advancement.

It can be provided particularly advantageously that, for an automatic compensation parameter determination, the idling current of the pull motor is operated at a rapid and at a slow speed of the wire electrode, for the determination of the target rpm of the pull motor.

The tapping of the actuation signals for the push motor can advantageously occur parasitically and/or via a galvanically separated input, alternatively via a sensor.

To carry out an automatic compensation parameter determination, in an advantageous embodiment, the idling current of the pull motor is acquired at a rapid and at a slow advancement speed of the wire electrode, and therefrom the target rpm at which the pull motor should be operated is derived,

Additional purposes, characteristics and advantageous possibilities of use of the present invention are described in the following description of embodiment examples in reference to the drawings. Here, all the characteristics described in words and/or represented pictorially constitute, in a reasonable combination thereof, the subject matter of the present invention, including independently of the claims and related claims.

In the drawing, the figures show:

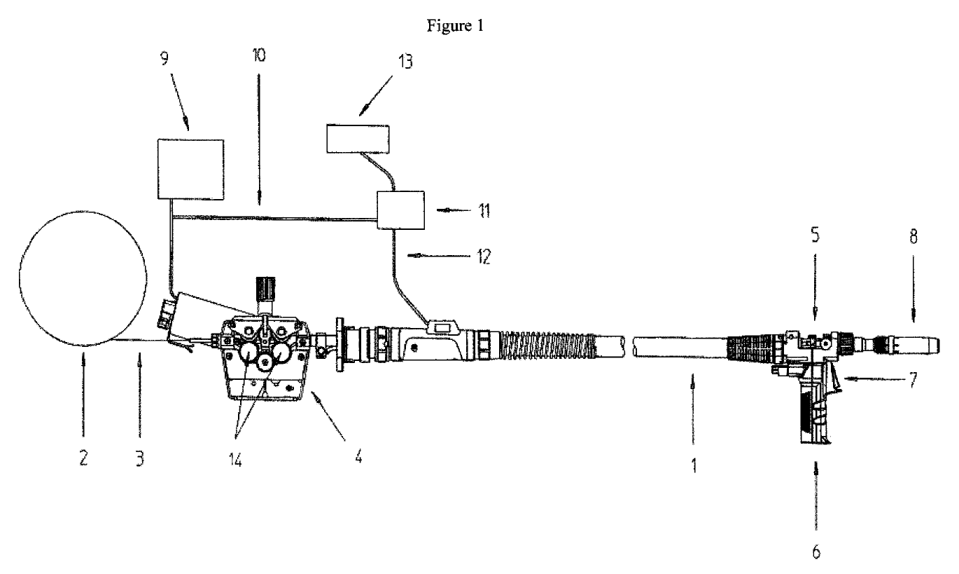

FIG. 1 diagrammatically the construction of an embodiment example of a welding and/or soldering system having a wear-off electrode according to the invention, which system comprises both a push drive and a pull drive,

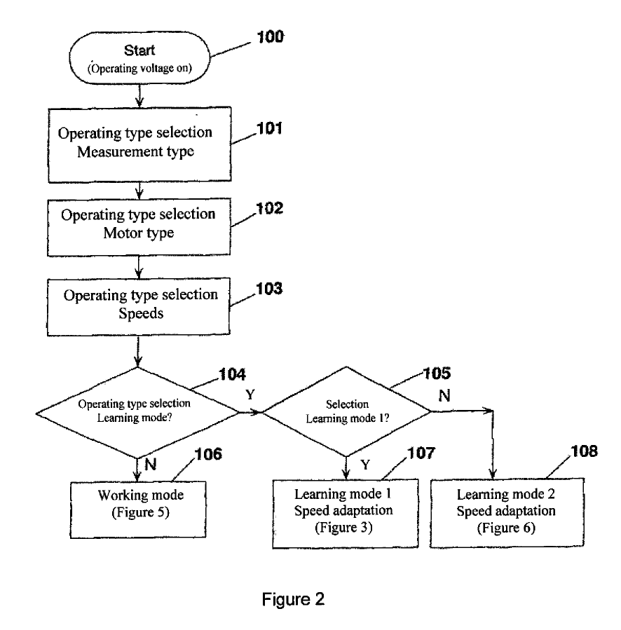

FIG. 2 a flow chart for the startup of an installation,

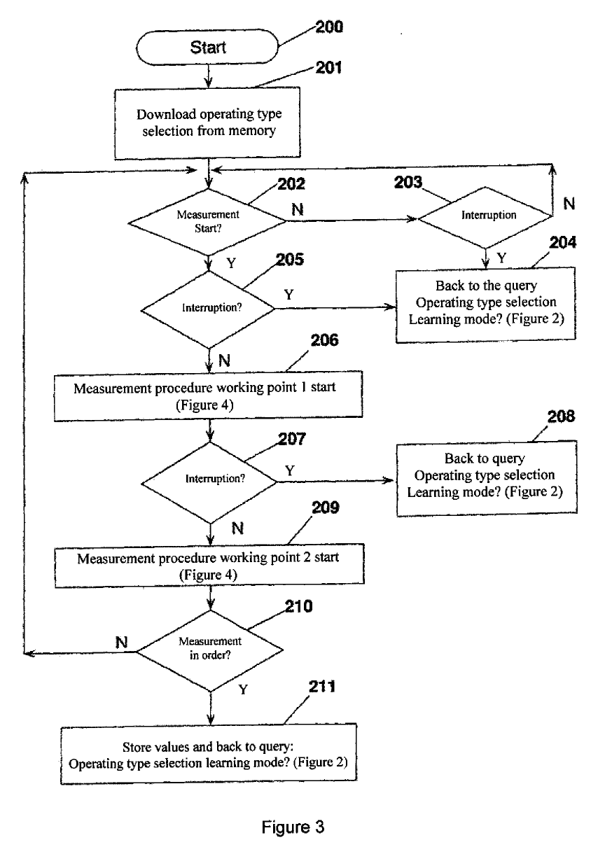

FIG. 3 a flow chart for the learning mode 1 of the flow chart of FIG. 2,

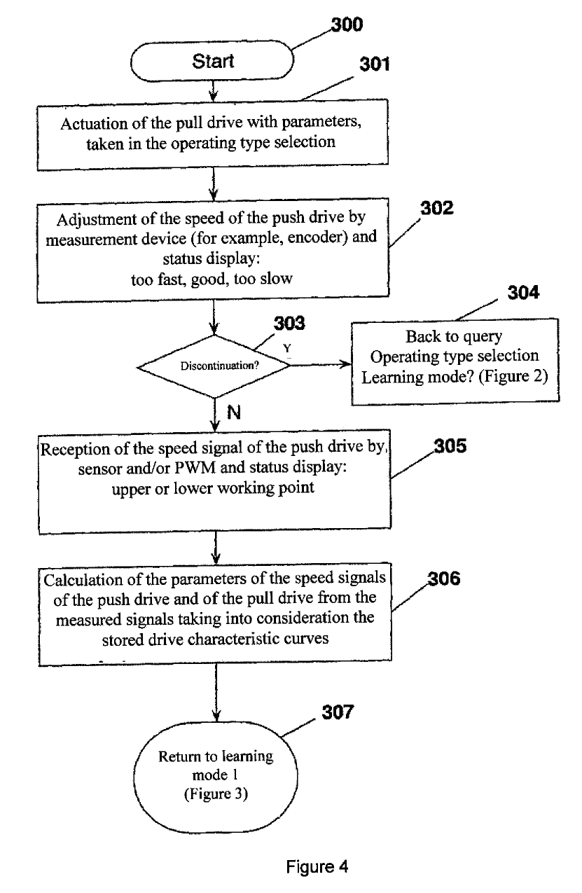

FIG. 4 a flow chart for the measurement procedure at the working point 1 or 2 of the flow chart of FIG. 3,

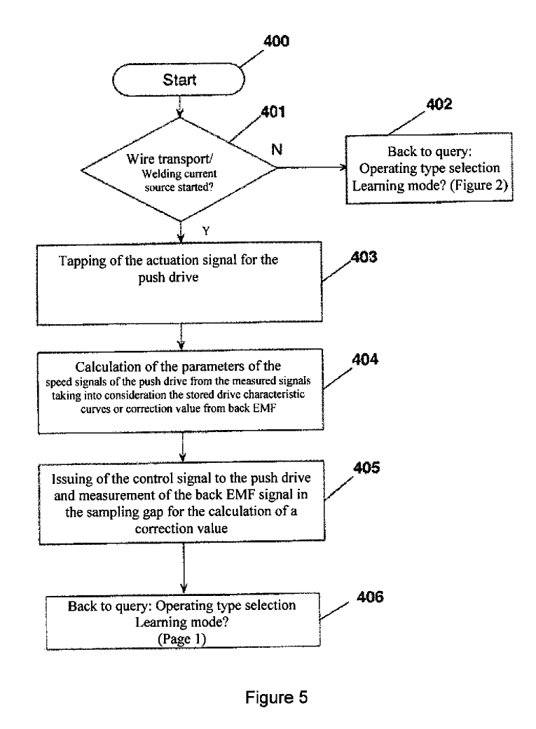

FIG. 5 a flow chart for the working mode of FIG. 2, and

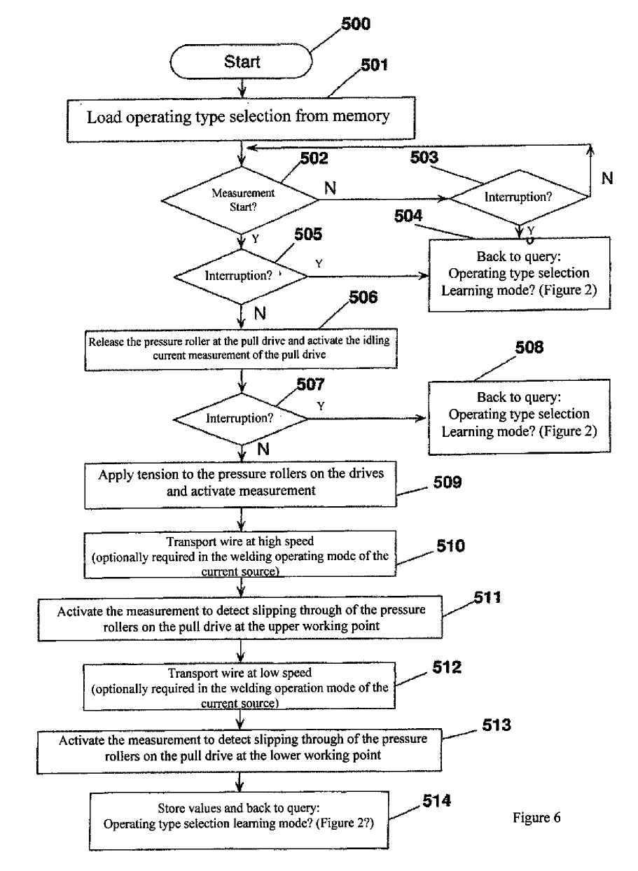

FIG. 6 a flow chart for the learning mode 2 of the flow chart of FIG. 2.

In FIG. 1, the welding and/or soldering system according to an embodiment of the invention is represented in the essential system portions that are of importance for the invention.

Reference numeral 1 designates a tube packet by means of which a wear-away wire electrode 3 is fed to the blowpipe from a wire supply 2 which is represented only diagrammatically. At the rear end of the tube packet 1, an electromotor push drive 4 is located, while a pull drive 5 is located at the other end of the tube packet 1. The latter pull drive 5 is integrated in a handle 6 which comprises an actuation switch 7. On the handle 6, a welding nozzle 8 is secured, through which the welding gas and the wire electrode 3 are fed to the welding site. The advancement of the wire electrode 3 and the gas feed are started, and interrupted again, via the actuation switch 7 on the handle 6 of the welding gun, as needed.

The system is supplied via a central current supply 9 which delivers the welding current, and which supplies current to the push drive 4 and the pull drive 5. The push drive 4 is connected via the measurement lines 10 to a central electronics unit 11. The pull drive 5 is also connected via control lines 12 to the electronics unit 11. The electronics unit 11 is supplied via an external current supply or welding current source 13 (preferably 35 . . . 48 VAC).

The push drive 4 comprises pressure rollers 14, for the purpose of advancing the wire electrode 3 with friction engagement to the welding nozzle 8. In contrast to the push drive 4, which is designed to press the wire electrode 3 in the direction of the welding nozzle 8, the pull drive 5 is designed to pull the wire electrode 3. The pull drive 5 thus supports the push drive 4, particularly in the case of very long tube packets 1, for which the length of the push drive 4 is insufficient to feed the wire electrode 3 without problem to the welding nozzle 8. In the case of very long tube packets 1 in particular, a jamming of the wire electrode 3 occurs within the guide tube, due to the large friction between the wire electrode 3 and the inner wall of the guide tube in the tube packet 1. To prevent such jamming, but also to ensure a steady advancement of the wire electrode 3 to the welding nozzle 8, the push drive 4 and the pull drive 5 have to be mutually adapted during the entire welding process.

For this purpose, the push and pull drives 4, 5 are actuated during the welding and/or soldering process for the transport of the wire electrode 3, as explained below in reference to the flow charts represented in FIGS. 2-6.

First, a flow chart for the startup of the operation of the system is described in reference to FIG. 2.

The system is started in step 100, wherein the operating voltage of the system is switched on. Then, in steps 101, 102 and 103, the measurement type, the motor type used in the system, and the required speeds are selected.

Subsequently, in step 104, a verification is carried out to determine whether the operating selection is a learning mode or a working mode. The learning mode, step 105, is selected if the system is started for the first time, or after a resetting process. The working mode, step 106, is selected if a learning mode has already been carried out during a previous operation.

If, in step 104, the learning mode was selected, a verification is carried out in step 105 to determine whether the learning mode 1 should be carried out next, or whether one should proceed to a learning mode 2. In accordance with the decision criteria in step 105, a transition occurs to the learning mode 1, step 107, or to the learning mode 2, step 108. The speed adaptation between the pull drive 5 and the push drive 4 can occur via the learning mode 1 or via the learning mode 2, depending on the type of the motor.

The individual process flows, which relate to the learning mode 1 (process step 107), the working mode (process step 106), and the learning mode 2 (process step 108), are represented in FIGS. 3, 5 and 6.

FIG. 4 shows, moreover, the measurement procedure at working points 1 or 2, which result from the learning mode 1, as represented in FIG. 3.

The flow of the learning mode 1, in accordance with the process step 107 of FIG. 2, occurs as follows.

After the start in step 200, in step 201, an operating type selection is downloaded from the memory. Said memory is integrated in the central electronics unit 11, which is shown in FIG. 1. After the operating type selection has been downloaded in step 201, it is decided, in step 202, whether the measurement should be started or not. If the measurement should not be started, the decision is made in step 203 whether an interruption should take place. If this decision is negative, the process flow returns to step 202, and if an interruption is to occur, there is a return, in step 204, back to Operating type selection Learning mode, and in particular step 104, of the flow chart of FIG. 2. If in step 202, the decision is made that the measurement should be started, then the flow proceeds to step 205, where again a decision must be made whether or not an interruption should occur. If an interruption is to take place, the process flow continues to step 204, otherwise, in step 206, the measurement procedure at the working point 1 is started. This process flow results from the flow chart of FIG. 4. The flow chart of FIG. 4 is also described below.

After the process step 206, a query “interruption?” again occurs in step 207; if an interruption is to occur, step 208 leads back to the query: “Operating type selection Learning mode?” and thus to the flow chart of FIG. 2.

If the decision is made in step 207 that no interruption is to take place, the measurement procedure at the working point 2 is started in step 209. This flow chart is represented in FIG. 4. After the process step 209, the query whether the measurement is in order occurs in step 210. If this question is affirmed, the determined values are stored in step 211. Subsequently, there is a return to the query “Operating type selection Learning mode?” of FIG. 2.

The flow of the measurement procedures at the working point 1 or at the working point 2, in accordance with the process steps 206 and 209 in FIG. 3, is represented in FIG. 4.

After the start in step 300, the adjustment of the pull drive occurs in step 301, with parameters that were taken in the operating selection. Subsequently, in step 302, the speed of the push drive is adjusted by means of the measurement device, for example, an encoder. In addition, a status display occurs, in the form: “too fast” or “good” or “too slow.” After step 302, the query whether an interruption should occur is made in step 303. If an interruption is required, the flow returns, via step 304, to the query “Operating type selection Learning mode?” of the flow chart of FIG. 2.

If, in step 303 no interruption is required, the speed signal of the push drive is received in step 305 by means of a sensor and/or PWM (pulse width modulation), and a status display: “upper working point” or “lower working point,” occurs. In step 306, the parameters of the speed signals of the push drive and of the pull drive are then calculated from the measured signals, taking into consideration the stored work characteristic curves. The flow chart of FIG. 4 then ends in step 307 with a return to the learning mode 1 of FIG. 3.

The working mode of the flow chart of FIG. 2 is represented in FIG. 5.

After the start in step 400, a wire transport should be started in step 401. In addition, a verification is carried out to determine whether the welding current source should be started or has been started. If the query is negative, the flow proceeds to step 402, and thus back to the query: “Operating type selection Learning mode?” in the flow chart of FIG. 2. When the wire transport/welding current in step 401 have been started, the actuation signal for the push drive is received, preferably parasitically, in step 403. Subsequently, in step 404, the parameter of the actuation signals of the push drive is calculated from the measured signals, taking into consideration the stored drive characteristic curves or the correction value from the back EMF. Step 405 follows, in which the issuing of the control signal to the push drive occurs, and the back EMF signal in the sampling gap is measured for the calculation of a correction value. With this, the working mode is completed, and, in step 406, the flow returns to the query: “Operating type selection Learning mode?” of the flow chart of FIG. 2.

Using the flow chart of FIG. 6, the learning mode 2 is now described, which is indicated in step 108 of FIG. 2. The learning mode 2 of FIG. 6, in the process steps 500-505 corresponds, to the process steps 200-205.

After the process step 505, if no interruption is to take place, the process step 506 then follows, in which the pressure roller on the pull drive is released, and the idling current measurement of the pull drive is activated.

Step 506 is followed by the steps 507 and 508, if an interruption is to take place, the latter steps corresponding to the process steps 207 and 208 of FIG. 2.

If no interruption is to take place in step 507, the pressure rollers are secured on the drives in process step 509, and the measurement is activated. In step 510, the transport of the wire at high speed, optionally in the welding operation mode of the current source, is carried out.

The flow proceeds to step 511 in which the measurement is activated, in order to detect a slipping through of the pressure rollers on the pull drive at the upper working point. In step 512, the transport of the wire at low speed follows. Optionally, this is carried out in the welding operation mode of the current source. Subsequently, in step 513, the measurement is activated, to detect a slipping through of the pressure rollers on the pull drive at the lower working point. In step 514, the values obtained are stored, and there is a return to the query: “Operating type selection Learning mode?” of FIG. 2.

The above described, detailed process flows show that, from the various measured and determined values, the pull motor is always adjusted during the welding to the same speed as the push motor in the current source.

It should be pointed out, that during the startup of a system, after the application of the voltage supply, all the settings are being loaded. In addition, the position of a sliding switch set specifically for the system is read in, and accordingly the characteristic curve is selected.

The process management, as described in the flow charts, can occur via signals which are displayed to the user, for example, via LEDs. When a certain first LED is blinking during the switching on, then the parameter determination has to be carried out. When this LED is off, the adjustment is ready for operation. Now the wire is threaded into the tube packet, and the pressure roller is closed. Subsequently, a switch is adjusted in such a manner that the previous LED is lit, which corresponds to “learning mode activated.”

Now a sensing device is actuated, so that the pull motor rotates at a faster speed. An LED associated for this purpose briefly flashes and is then lit permanently, which means: “the finding of the upper working point has started.” The push motor is now adjusted, for example, to a wire speed of approximately 12 meters/minute.

Now, a corresponding sensing device is actuated again, an additional LED flashes, which means that parameters are being determined. When said additional LED is lit permanently, the determination of the upper working point has been completed. Now, a slow wire speed of approximately 4 meters/minute is adjusted on the push motor. The corresponding sensing device is actuated again, and the additional LED, which was lit permanently last, is switched off. Now another LED flashes briefly, and subsequently is lit permanently. The pull motor rotates at a slower speed, and this corresponds to the process step: “the finding of the lower working point has started.” The main switch is actuated anew, and the other LED flashes during the parameter determination. When this LED is then switched off, the parameter determination has been completed. If, after the extinction of this LED, the above first mentioned first LED is lit permanently, the determination of the parameters has taken place without error. However, if said first LED flashes, then erroneous parameters have been determined. In this case, a new parameter determination is carried out.

### LIST OF REFERENCE NUMERALS FOR FIG. 1

1 Packet
2 Wire supply
3 Wire electrode
4 Push drive
5 Pull drive
6 Handle
7 Actuation switch
8 Welding nozzle
9 Current supply
10 Measurement line
11 Central electronics unit
12 Control line
13 External current supply source or welding current source
14 Pressure roller

1. Electronic circuit for connecting a pull drive (5), which is designed and intended to pull a wire electrode (3) through a protective tube, to a welding and/or soldering system which comprises a push drive (4) for advancing a wire electrode (3), wherein the electronic circuit is designed to receive actuation signals for the push drive (4), and to control and/or adjust the pull drive (5) using the respective current actuation signals for the push drive (4), synchronously with the push drive (4) at the same drive speed, characterized in that the electronic circuit, from the actuation signals for the push drive (4), determines compensation parameters, and the electronic circuit, for the determination of the compensation parameters, determines and processes the time integral over the voltage or the current strength of the actuation signal for the push drive (4).

2. Electronic circuit according to claim 1, characterized in that the electronic circuit is designed to receive—particularly parasitically tapped—actuation signals for the push drive (4), and in that the electronic circuit, in a learning mode, determines the compensation parameters from the actuation signals for the push drive (4), and in that the electronic circuit is designed to control and/or adjust, in a working mode, the pull drive (4) using the respective current actuation signals for the push drive (4), and using the determined compensation parameters, synchronously with the push drive (4) and at the same drive speed.

3. Electronic circuit according to claim 1, characterized in that a memory is provided in which characteristic curves, particularly the voltage-rpm characteristic curves for different pull drives (5) are stored, wherein a fitting characteristic curve is selectable by means of a DIP switch and/or software.

4. Electronic circuit according to claim 3, characterized in that the electronic circuit takes into consideration a selected characteristic curve in the determination of the compensation parameters and/or in the generation of actuation signals for the pull drive (5).

5. Electronic circuit according to claim 1, characterized in that the electronic circuit is designed to receive and to process a pulse width modulated actuation signal for the push drive (4).

6. Electronic circuit according to claim 1, characterized in that the electronic circuit is designed to control a pull drive (5) via by a pulse width modulation (PWM) and/or in that the electronic circuit is designed to control a pull drive (5) by voltage modulation or by current modulation.

7. Electronic circuit according to claim 1, characterized in that the electronic circuit monitors, in a working mode, the drive speed of the pull drive (5) and/or the equality of the drive speeds of the push drive (4) and the pull drive(5), continuously or at predetermined or predeterminable time intervals.

8. Electronic circuit according to claim 1, characterized in that the electronic circuit measures the current drive speed of the pull motor (5) via the electromotive force, which represents, in a sampling gap, when no current is applied to the pull motor(5), the drive speed thereof, and uses it for the adjustment and/or in that the electronic circuit measures the current drive speed of the pull motor (5) via the electromotive force, which, in a sampling gap, when no current is applied to the pull motor(5), represents the drive speed thereof, and uses it for the adjustment, and, from the measured drive speed and the current actuation signals for the push drive (4), it adjusts a duty factor for a pulse width modulated actuation of the pull drive(5).

9. Welding and/or soldering system or tube packet for a welding and/or soldering system or pull drive (5) having an electronic circuit according to claim 1.

10. Method for universally controlling the advancement of the wear-away wire electrode (3) of welding and/or soldering systems, wherein the wire electrode (3) is taken from a wire supply (2) and fed to a welding head from the wire supply (2) through a protective tube, wherein the wire electrode (3) is both advanced by means of a push drive (4) and pulled by means of a pull drive(5), which are preferably arranged in the region of the respective ends of the protective tube that are actuated in keeping with a required advancement speed of the wire electrode, wherein the pull drive (5) is controlled and/or adjusted by using and/or evaluating actuation signals for the push drive (4), characterized in that, from the actuation signals for the push drive (4), compensation parameters are determined, and for this the time integral over the voltage or the current strength of the actuation signal for the push drive (4) is determined and processed.

11. Method according to claim 10, characterized in that compensation parameters are determined from actuation signals—particularly actuation signals tapped parasitically and/or in a learning mode—for the push drive (4), and in that, in a working mode, the pull drive (5) is controlled and/or adjusted using the respective current actuation signals for the push drive (4), and using the determined compensation parameters, synchronously with the push drive (4) and at the same drive speed.

12. Method according to claim 10, characterized in that the current drive speed of the pull motor (5) is measured via the electromotive force which represents, in the sampling gap, when no current is applied to the pull motor (5), the speed thereof and is used for the control and/or adjustment of the pull motor(5).

13. Method according to claim 10, characterized in that a characteristic curve that fits the pull motor (5) used is retrieved from a memory, in which characteristic curves of different pull motors (5) are stored, and in that this fitting characteristic curve is downloaded and/or set as a fixed quantity by means of a DIP switch and/or software.

14. Method according to claim 10, characterized in that, for the determination of the compensation parameters, the wire speed is determined and at the same time the associated actuation signals for the push motor (4) are measured and/or processed, and/or in that, for the determination of the compensation parameters for different wire speeds, the associated actuation signals for the push motor (4) are measured and/or processed.

15. Method according to claim 11, characterized in that the pull motor (5) is adjusted using the compensation parameters in the working mode of the system to the same drive speed as the push motor (4).

16. Method according to claim 10, characterized in that the actuation signals of the push motor (4) are determined via a galvanically separated input or a sensor, and with the selected characteristic curve they are compensated by calculation and/or adapted, and a resulting new quantity is used as target value for the adjustment of the pull motor (5) in the operating state.

17. Method according to claim 10, characterized in that the pull motor (5) is actuated via a pulse width modulation (PWM) or a voltage modulation or a current modulation.

18. Method according to claim 10, characterized in that, in a working mode, the drive speed of the pull drive (5) and/or the equality of the drive speeds of the push drive (4) and of the pull drive (5) are monitored, continuously or at predetermined or predeterminable time intervals.

19. Method according claim 10, characterized in that—particularly at predetermined time intervals—the drive speed of the motor of the pull drive (5) is determined via the electromotive force (EMF) which then, in the sampling gap, when no current is applied to the pull motor (5), represents the drive speed of the motor of the pull drive (5) (back EMF), and in that, from this drive speed and the required target speed for the actuation of the motor of the push drive (4), a duty factor of the pulse width modulation (PWM) for the pull drive (5) is adjusted.

20. Method according to claim 10, characterized in that, for the determination of a target drive speed of the pull motor(5), the drive speed of the pull motor (5) is determined at which a driving roller of the pull motor (5) for the advancement of the wire electrode (3) presents no slip on the wire electrode (3), and runs at a circumferential speed that corresponds exactly to the advancement speed of the wire electrode (3) reached by means of the push motor (4).

21. Method according to claim 10, characterized in that, for an automatic compensation parameter determination, the idling current of the pull motor (5) is operated at a fast and at a slow speed of the wire electrode (3) for the determination of the target rpm of the pull motor (5).
